(19) United States
(12) Patent Application Publication
(10) Pub. No.: US 2011/0138540 A1
(43) Pub. Date: Jun. 16, 2011

(54) MULTI-FUNCTION TOOL APPARATUS AND SYSTEM

(75) Inventors: Terry Kinskey, Alpharetta, GA (US); Matthew Williams, Lighthouse Point, FL (US)

(73) Assignee: Union Rich USA, Pompanoo Beach, FL (US)

(21) Appl. No.: 12/524,847

(22) PCT Filed: Jan. 30, 2008
(86) PCT No.: PCT/US08/52534

§ 371 Date: Dec. 16, 2010

Related U.S. Application Data
(60) Provisional application No. 60/898,357, filed on Jan. 30, 2007.

(51) Int. Cl. B25F 1/00; B25G 1/08; B26B 11/00

(52) U.S. Cl. 7/105; 30/165; 7/158; 7/156; 7/167

(57) ABSTRACT

A multi-function tool apparatus and system, comprising a handle and a utility blade having a structure that accommodates a plurality of functions, thus, reducing the number of ancillary tools required by a painter. The handle includes a butt end that is a screwdriver in threaded engagement with the handle. The screwdriver can be removed to expose a shaft and several screwdriver bits. The butt end includes a bolt in threaded engagement with the butt end. The bolt can be removed to attach an elongated pole to allow the apparatus to reach remote areas. The structure of the utility blade allows functions including but not limited to: scraping; putty spreading; caulk scraping; can opening, can closing; roller wiping; cutting; torquing hex nuts on spray guns; nail pulling, nail driving and the like.

### CROSS-REFERENCE AND PRIORITY CLAIM TO RELATED APPLICATION

To the fullest extent permitted by law, the present Patent Cooperation Treaty Patent Application claims priority to and the benefit of United States Provisional Application entitled “Multi-function Tool Apparatus and System,” filed on Jan. 30, 2007, having assigned Ser. No. 60/898,357.

### BACKGROUND OF THE INVENTION

I. Field of the Invention

The present invention relates generally to the field of tools, and more particularly to a multi-function tool that provides functionality common to painters' needs.

II. Description of the Related Art.

Often times, workers, such as painters, require supporting tools to perform their tasks. In addition to the basic equipment required by a painter, such as a paint brush and paint roller, a painter may require various additional pieces of equipment to perform necessary functions, such as scraping, various cutting tasks, spreading, cleaning rollers, scraping caulk, removing lids from paint cans, hammering nails, driving screws, and the like. It is appreciated that each of these tasks requires separate tools, the carrying and organization of which can burden the painter.

Thus, it is readily apparent that there is a need for a multi-function tool apparatus and system that allows a painter, or other worker, to conveniently perform many tasks or functions using a single tool or tool system.

### SUMMARY OF THE INVENTION

Briefly described in a preferred embodiment, the present invention overcomes the above-mentioned disadvantages and meets the recognized need for such an invention by providing a multi-function tool apparatus and system comprising a handle and a utility blade operable to accommodate a plurality of functions, thus, reducing a number of ancillary tools required by a painter, or other worker.

According to its major aspects and broadly stated, the present invention, in its preferred form, is a multi-function tool apparatus and system comprising a handle having a butt end that includes a screwdriver in threaded engagement with the handle. The screwdriver may be removed to expose a shaft and a plurality of screwdriver bits of varying configuration. The butt end further preferably includes a bolt in threaded engagement therewith. The bolt may be removed to attach an elongated pole to allow performance of tasks or functions at remote areas. The structure of the utility blade preferably accommodates a plurality of functions including, but not limited to, scraping, putty spreading, caulk scraping, can opening, roller wiping, cutting; turning threaded fasteners; nail pulling, nail driving, and the like.

The system may further include one or more replaceable blade or point tips for replacement of a cutting blade or scraping point of the multi-function tool, which cutting blade or scraping point may be prone to wear, and may become worn to an extent that it is no longer useful well before other features of the tool have become worn or damaged through ordinary use. The replaceable blade(s) and/or point(s) are preferably retained in engagement with the multi-function tool via a removable sleeve that captures a replaceable blade or point and secures it to the utility blade of the multi-function tool. Disengagement of the sleeve from the utility blade preferably allows a worn blade or point to be replaced with a new blade or point.

In general, according to one aspect, the invention features a tool apparatus including a handle, a utility blade disposed on one end of the handle, and a butt end disposed on another end of the handle. The utility blade may include a first utility edge disposed on a first side portion thereof, a second utility edge on a second side portion thereof, and a third utility edge disposed between the first and second utility edges, generally defining a forward edge of the utility blade. Each utility edge may include one or more structures for performing associated tasks, such as a circular arc segment section for scraping a paint roller, a paint can opening level, a polygonal cutout for engaging a bolt head, a straight sharp cutting, scraping, and/or spreading edge, a curved sharp cutting and/or scraping edge, a cutting and/or scraping point and/or blade, or the like. Additionally, the utility blade may include one or more utility feature disposed on or through a broad surface of the blade, such as an aperture adapted to pull nails, or the like.

The handle includes a central handle portion, a butt portion in threaded engagement with the central handle portion and a bolt end in threaded engagement with the butt portion. The butt portion may include a sub-tool inverted to face inwards of a hollow interior of the handle. The inverted sub-tool is preferably a screwdriver removably attached to the handle via threading. When the bolt end is engaged with the butt portion, the bolt may be for hammering, such as to drive nails, or the like. The screwdriver may include a plurality of removable and interchangeable driver bits whereby a plurality of different fasteners of differing types may be rotated by the screwdriver. The bits are preferably housed in receiving sockets formed in the screwdriver for convenience and to prevent loss thereof. When the bold is removed from the butt portion, a rod or other member may be engaged with the butt portion, such as in order to reach remote areas for scraping, or the like.

In another aspect, the invention features method for performing painter's functions including providing a tool having a handle with a multifunctional blade having a first edge with a concave aperture, a second edge with a concave aperture and a hex profiled aperture, a third straight edge disposed between the first and second edges and having a first protrusion adjacent the first edge and a second protrusion adjacent the second edge, and a through-hole disposed on the multifunctional blade. The method further includes the steps of inserting a paint roller within the concave aperture on the first edge and running the paint roller along an edge of the concave aperture to clean the paint roller, spreading putty with the straight edge, scraping a surface with the straight edge, scraping caulk with the second protrusion, removing a lid from a paint can with the first protrusion, and/or removing a nail with the through-hole. The method may further include the steps of hammering an object with a bolt engaged with butt portion of the handle, removing the butt portion of the handle and rotating a fastener with a screwdriver of the butt portion, and/or removing a bolt from engagement with the butt portion and engaging an extension pole with the butt portion. The method may further include the steps of engaging a removable point or blade with a protrusion of the utility blade and securing the removable point or blade to the utility blade via a covering sleeve.

Accordingly, one feature and advantage of the present invention is its ability to provide a single tool apparatus capable of performing a plurality of tasks or functions associated with painting or other work, whereby the number of tools required by a painter or other workman may be reduced.

Another feature and advantage of the present invention is its ability to provide a removable screwdriver operable with a handle carrying a utility blade, whereby the screwdriver and a plurality of bits associated therewith may be stored and protected when not in use and may be conveniently carried by the handle and utility blade when not in use.

Another feature and advantage of the present invention is its ability to provide replaceable cutting blades and/or points, whereby replacement of the entire tool due to premature wear and/or damage to one portion thereof may be avoided.

These and other features, objects and advantages of the present invention will become more apparent to one skilled in the art from the following description and claims when read in light of the accompanying drawings.

### BRIEF DESCRIPTION OF THE DRAWINGS

Accordingly, the present invention will be understood best through consideration of, and with reference to, the following drawings, viewed in conjunction with the Detailed Description of the Invention referring thereto, in which like reference numbers throughout the various drawings designate like structure, and in which:

FIG. 1 is a perspective view of an embodiment of a multi-function tool apparatus according to the present invention;

FIG. 2 is a perspective cross-sectional view of the multi-function tool apparatus of FIG. 1;

FIG. 3 is an exploded rear perspective view of the multi-function tool apparatus of FIG. 1 according to the present invention;

FIG. 4 is a rear perspective view of an extension accessory operable with the multi-function tool apparatus of FIG. 1;

FIG. 5 is a top exploded view of a cutting blade or point accessory operable with the multi-function tool apparatus of FIG. 1;

FIG. 6 is a rear view of a bolt end of the multi-function tool apparatus according to an alternate embodiment;

FIG. 7 is a partially-exploded view of the cutting blade or point accessory of FIG. 5 illustrating engagement thereof with the multi-function tool apparatus of FIG. 1;

FIG. 8 is a top view of the cutting blade or point accessory of FIG. 5 engaged with the multi-function tool apparatus of FIG. 1;

FIG. 9 is detail perspective view of replaceable cutting blade of the accessory of FIG. 5;

FIG. 10 is a cross-sectional view of a retaining sleeve of the accessory of FIG. 5; and

FIG. 11 is a rear view of the retaining sleeve of FIG. 10.

It is to be noted that the drawings presented are intended solely for the purpose of illustration and that they are, therefore, neither desired nor intended to limit the invention to any or all of the exact details of construction shown, except insofar as they may be deemed essential to the claimed invention.

### DETAILED DESCRIPTION OF THE INVENTION

To the fullest extent permitted by law, the present Patent Cooperation Treaty Patent Application claims priority to and the benefit of United States Provisional Application entitled “Multi-function Tool Apparatus and System,” filed on Jan. 30, 2007, having assigned Ser. No. 60/898,357.

In describing preferred embodiments of the present invention illustrated in the drawings, specific terminology is employed for the sake of clarity. The invention, however, is not intended to be limited to the specific terminology so selected, and it is to be understood that each specific element includes all technical equivalents that operate in a similar manner to accomplish a similar purpose.

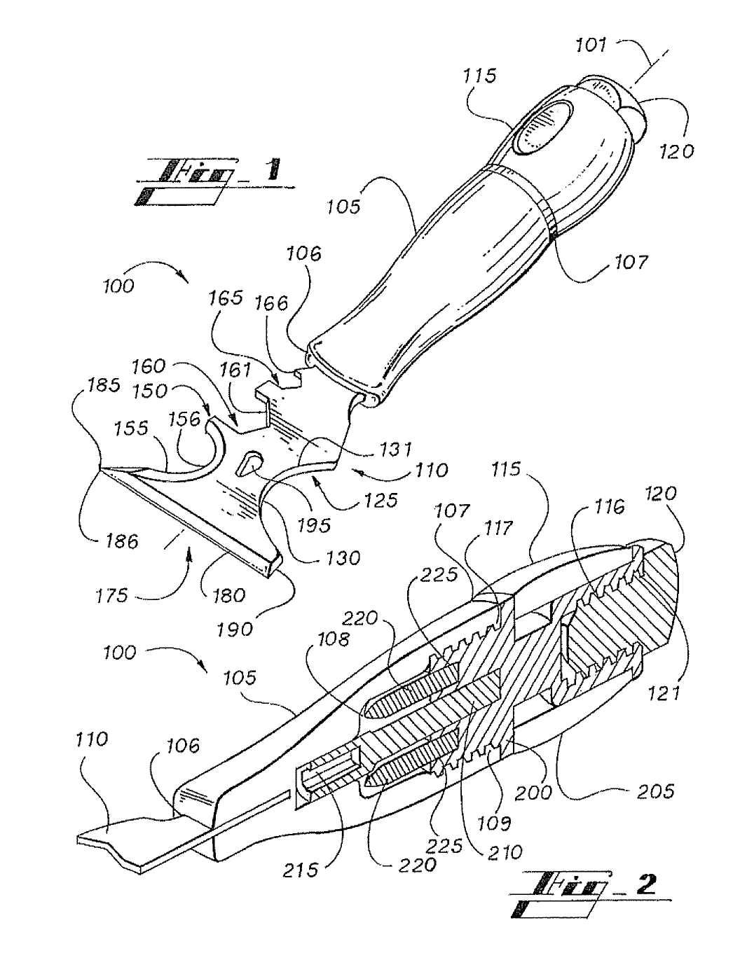

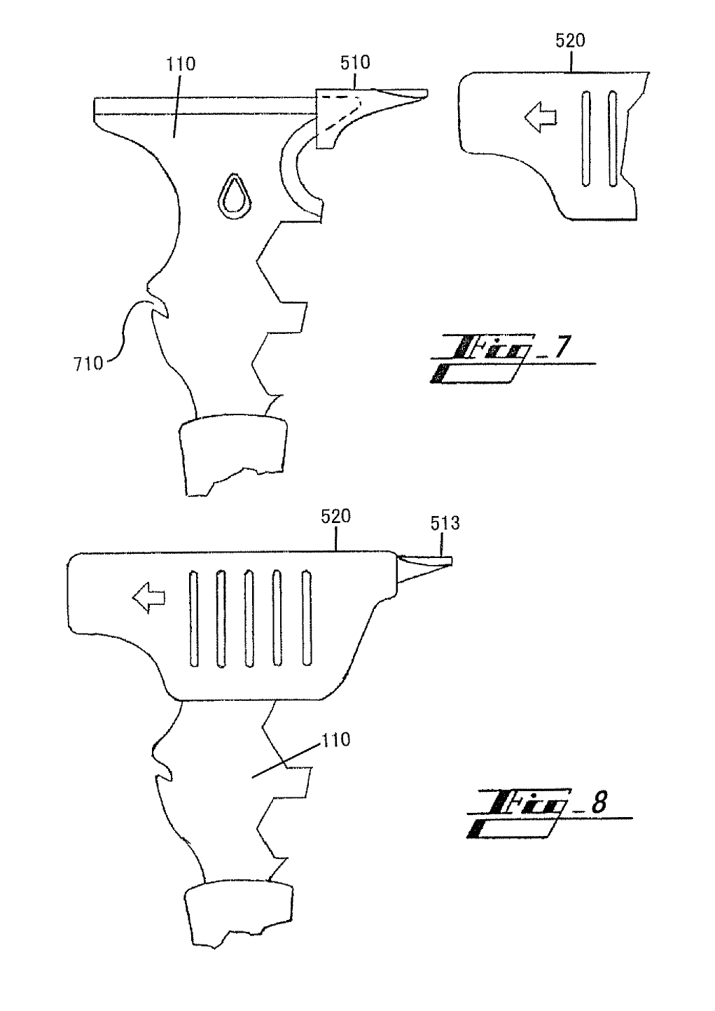

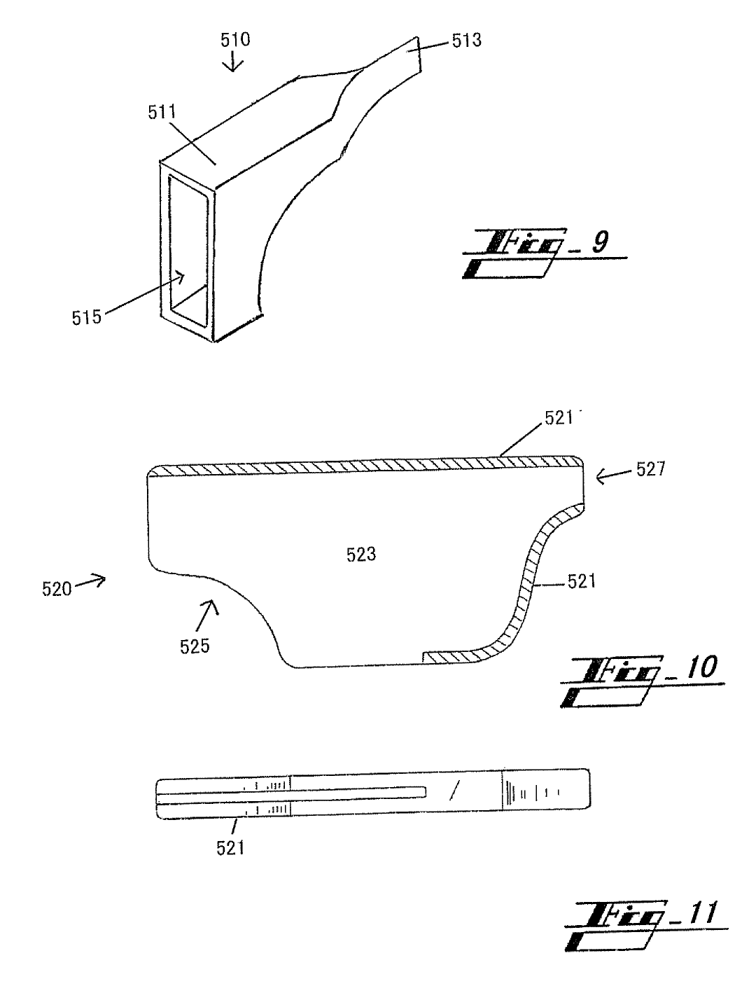

In that form of the present invention chosen for the purpose of illustration, FIGS. 1-11 show multi-function tool apparatus 100 comprising handle 105, utility blade 110, and bolt end 120, sub-tool 200, bolt end 120, elongated rod 400, and replacement blade or point accessory 500 comprising replaceable blade or point 510 and sleeve 520.

Now referring to FIGS. 1-3, by way of example, and not limitation, there is illustrated multi-function tool apparatus 100 which preferably includes handle 105 having forward end 106 and rear end 107. It should be appreciated that handle 105 may be formed in a variety of shapes, configurations, dimensions, and orientations, as desired, for, aesthetics, comfort, and/or ease of use. In a typical implementation, handle 105 preferably has a generally circular cross-section tapering slightly from rear end 107 to forward end 106. It should also be appreciated that handle 105 may be formed of one or more of a variety of materials with varying gripping characteristics and a variety of textures to aid in gripping. In a typical implementation, handle 105 preferably includes soft synthetic rubber, such as Santoprene.

Apparatus 100 preferably further includes utility blade 110 disposed on forward end 106 of handle 105. It should be appreciated that utility blade 110 is preferably attached to forward end 106 so as to provide structural support for utility blade 110, such as by a tine inserted to a sufficient depth within handle 105, whereby forces may be applied to utility blade 110 and or a surface in contact therewith, via handle 105. Utility blade 105 preferably includes a plurality of structures configured for use as tools, such as those described in greater detail below.

Apparatus 100 preferably further includes butt end 115, which is preferably operable with rear end 107 of handle 105, such as via threads 117 and 109. Butt end 115 preferably comprises a portion of handle 105 which may be gripped by a user when in threaded engagement with rear end 107. Apparatus 100 may further include bolt end 120 operable with butt end 115, such as via threads 121 as shown in FIG. 2. Preferably, bolt end 120 is formed of a substantially rigid or hard material, such as metal, that is suitable for driving nails, sealing paint can lids, or other hammering tasks. Butt-end 115 preferably includes internal threads 116, shown in FIG. 2, that engage threads 121 of bolt end 120 to allow butt end 115 and bolt end 120 to be engaged.

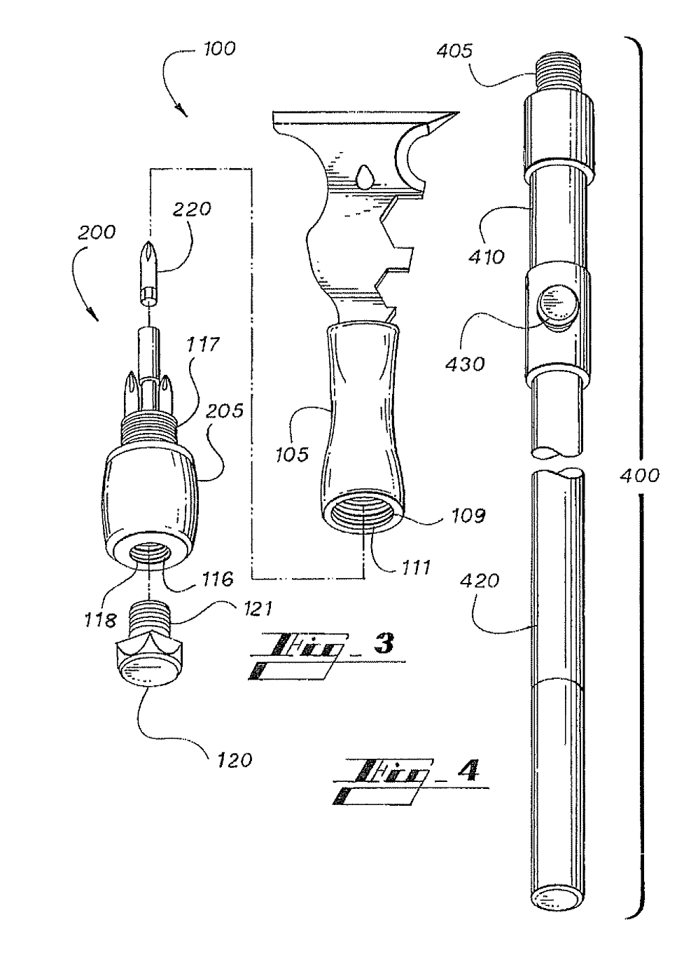

As mentioned above, butt end 115 preferably includes sub-tool 200, shown in cross-section in FIG. 2 and shown in perspective in FIG. 3. Sub-tool 200 may be inserted into hollow interior 108 of handle 105, also shown in FIG. 2. In a typical embodiment, sub-tool 200 preferably comprises a screwdriver wherein butt end 115 functions as handle 205 of sub-tool 200 when removed from engagement with rear end 117, as shown in FIG. 3. Sub-tool 200 preferably further includes shaft 210 operable with handle 205. Shaft 210 preferably includes female aperture 215 for receiving one of a plurality of driving bits 220 of various configurations. Driving bits 220 may preferably be stored in a respective plurality of storage recesses 225, preferably disposed in handle 205 generally circumferentially about and proximate shaft 210. It should be appreciated that driver bits 220 may optionally be single or double ended as is known in the art. Driver bits 220 and female aperture 215 preferably further include complimentary cross-sections that allow stable mating, such that a torque may be applied to driver bits 220 without rotation thereof within female aperture 215. Such a cross-section may optionally be hexagonal, although alternative shapes, such as square, diamond, cross-shaped, or other shapes may be employed. As mentioned above, sub-tool 200 preferably includes threads 117 for engagement with internal threads 109 of handle 105, both of which preferably allow butt end 115 and handle 105 to be threadably engaged and disengaged.

Now referring more particularly to blade 110, a plurality of utility edges, such as first utility edge 125, second utility edge 150, and third utility edge 175, may be provided. As further discussed in the description below, utility edges 125, 150, and 175 include one or more shape(s), curve(s), contour(s), cut-out(s), and or projection(s) that enable performance of a plurality of tasks. First utility edge 125 preferably includes at least one concave curve 130 defining a well in first utility edge 125. Concave curve 130 preferably defines a circular arc segment profile defining the well, and preferably includes blunt edge 131. Concave curve 130 is preferably configured and adapted to receive a typical paint roller therein for cleaning the paint roller by scraping, wherein apparatus 100 may be used to run blunt edge 131 along a portion of the paint roller surface to aid in paint extraction, preferably in conjunction with water and soap or other solvent.

Second utility edge 150 preferably includes at least three concave structures 155, 160, and 165, each defining a well in second utility edge 150. Concave curve 155 preferably defines a circular arc segment profile and includes sharp edge 156. Concave curve 155 may be used as a cutting edge for cutting a variety of materials, such as for cutting natural or synthetic fibers, including woven materials, paper, plastic, rubber, wires, wood, or other material. Concave curves 160 and 165 each preferably includes a plurality of blunt edges 161 and 166, respectively. In a preferred embodiment, concave curves 160 and 165 each includes four respective substantially straight edges 161, 165 that preferably define a well having a semi-hexagonal profile. It should be appreciated that concave curves 160 and 165, therefore, may be configured adapted to receive and engage a typical hexagonal nut, bolt, or other structure having a similar hexagonal profile, which may, for example, be found on a paint sprayer or other device or container with which a user may work. Thus, concave curves 160 and 165 may preferably be utilized to loosen or tighten nuts, bolts, or other fasteners of paint sprayers or other devices or containers.

Third utility edge 175 is preferably disposed between first and second utility edges 125 and 150, and generally perpendicular to, preferably within 15 degrees of perpendicular to, longitudinal axis 101 defined along a length of apparatus 100. Third utility edge 175 is preferably generally straight and preferably includes two end protrusions 185 and 190 proximate second utility edge 150 and first utility edge 125, respectively. Third utility edge 175 preferably includes straight sharp edge 180, which may preferably be used for scraping, cutting, spreading, or the like, thereby functioning as a combination scraper and putty knife. First protrusion 185 preferably terminates in point 186, which may preferably be used, for example, as a caulk scraper. In a typical embodiment, first protrusion 185 is preferably contiguous with both straight sharpen edge 180 and cutting edge 156. Alternatively, point 186 may be replaced by a blade having an extended sharp edge between straight sharp edge 180 and cutting edge 156. Second protrusion 190 is preferably formed as a blunt end that may preferably be implemented as level, such as to open a paint can, a spackle container, or the like. It should be understood that second protrusion 190 is preferably used to pry tops or lids off cans or containers, or for other similar prying or leveling tasks.

Utility blade 110 preferably further includes through-hole 195 disposed therethrough. Through-hole 195 may preferably include any of a variety of shapes and cross-sections. As shown in FIG. 1, through-hole 195 is preferably has a tear-drop shape for advantageously receiving nail heads through a larger portion thereof and for gripping the nail shaft and/or head proximate a narrower portion. Thus, through-hole 195 may be used for pulling nails, or the like.

Thus, apparatus 100 is preferably capable of performing several functions useful to painters, or other workers, including, but not limited to, cleaning paint rollers, applying putty and/or other substances, scraping flat surfaces, scraping joints, cracks, or crevices, cutting, rotating threaded fasteners or other devices having hexagonal, or other, patterns, pulling nails, opening cans, driving nails, or the like.

As shown in FIG. 3, apparatus 100 preferably includes a rear opening 111 including threads 109 adapted to engage threads 117 of handle 205. Furthermore, handle 205 preferably includes opening 118 including threads 116 operable to engage with threads 121 of bolt end 120. As will be appreciated from the figures, the three components 100, 200, and 120 are preferably removably engageable with one another and may optionally be included together as a system or kit. FIG. 4 illustrates elongated rod 400, usable as an extension pole, preferably having threaded end 405 adapted to engage opening 118 via threads 116 when bolt end 120 is removed. As such, elongated rod 400 may optionally be used to connect to sub-tool 200 alone or to sub-tool 200 in threaded engagement with handle 105, wherein elongated rod 400 may preferably be used to reach remote locations where the functionality of apparatus 100 or sub-tool 200 is required or desired. In a typical implementation, elongated rod 400 may optionally be included with other components 100, 200, 120 as a system or kit. Elongated rod 400 preferably includes first rod section 410 and second rod section 420 engageable via locking button 430. Either or both of sections 410 and 420 may preferably include a telescoping feature, such that elongated rod 400 may be extended and/or retracted along a spectrum of lengths. Locking button 430 is preferably operable to lock the respective orientation of rod sections 420 and 430 into position.

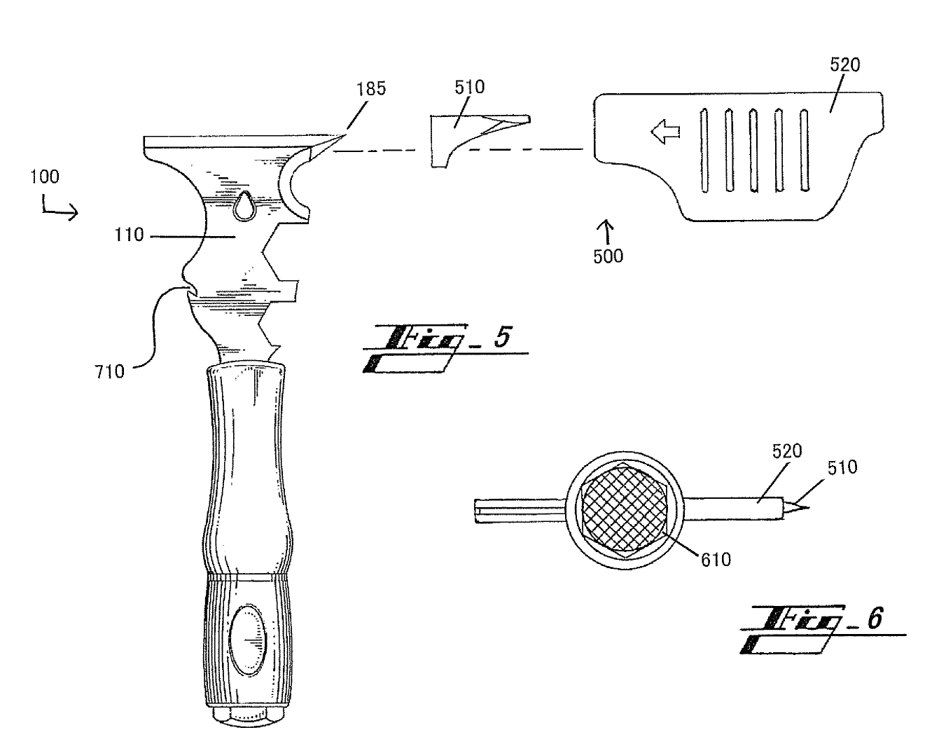

Now referring to FIGS. 5-11, accessory 500 comprising replaceable point or blade 510 and retaining sleeve 520 is illustrated. Replaceable point or blade 510 preferably comprises body 511 having point or blade 513 formed on a forward exterior portion and cavity 515 formed in a rearward portion thereof. Point or blade 513 is preferable adapted for use in cutting, scraping of the like, similar to point 185 of utility blade 110. Cavity 515 is preferably adapted to seat on point 185, whether worn or not, whereby point or blade 513 may provide a new point or blade in place of point 185. Replaceable point or blade 510 may preferably be retained in engagement with point 185 via encapsulation of replaceable point or blade 513 and at least a portion of utility blade 110 with retaining sleeve 520. Accordingly, retaining sleeve 520 preferably comprises body 521 generally enclosing space 523. In use, replaceable point or blade 510 and at least a portion of utility blade 110 may be inserted into space 523 via first aperture 525. When completely inserted, at least a portion of point or blade 513 preferably projects from second aperture 527 and is exposed for use. Retaining sleeve 520 preferably securely engages at least a portion of utility blade 110, whereby accidental or unintentional removal of retaining sleeve 520 is substantially prevented. As mentioned above, point 185 may become dull through normal use for cutting and/or scraping before other structures of apparatus 100 wear out or break. Without accessory 500, apparatus 100 may need to be replaced unnecessarily. Thus, accessory 500 preferably prolongs a useful life of apparatus 100.

As will be understood by those ordinarily skilled in the art, numerous additional features and combinations of features may be included, additionally or alternatively, without departing from the scope of the present invention. For example, bolt end 120 may be replaced by bolt end 610 having a textured exterior surface, such as a waffle pattern, as is known in the hammer art. Likewise, bottle opener cut-out 710 may be included on first utility edge 125. Thus, the foregoing description and drawings comprise illustrative embodiments of the present invention, and having thus described such exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A tool apparatus, comprising:
a handle;
a blade disposed on a first end of said handle; and
a butt end removably operable with a second end of said handle.

2. The apparatus of claim 1, wherein said butt end comprises a sub-tool operable to be stored in a hollow interior of said handle via engagement of said butt end with said second end of said handle.

3. The apparatus of claim 2, wherein said sub-tool comprises a screwdriver removably attachable to said handle.

4. The apparatus of claim 1, wherein said blade comprises a first utility edge.

5. The apparatus of claim 4, wherein said blade further comprises a second utility edge.

6. The apparatus of claim 5, further comprising a third utility edge disposed between said first utility edge and said second utility edge.

7. The apparatus of claim 1, further comprising a tool edge comprising:
a first well operable to scrape a paint roller brush; and
a first projection operable to pry a lid from a paint can.

8. The apparatus of claim 1, further comprising a tool edge comprising:
a second well operable to apply a torque to a hexagonal structure;
a third well disposed adjacent said second well and operable to apply a torque to a hexagonal structure;
a fourth well disposed adjacent the third well and comprising a cutting edge; and
a second projection comprising at least one of a point and a cutting edge.

9. The apparatus of claim 1, further comprising a tool edge disposed on a first end of said blade, said tool edge comprising:
a substantially straight sharp edge;
a first projection proximate a first end of said substantially straight sharp edge, said first projection operable to pry a lid from a paint can; and
second projection proximate a second end of said substantially straight sharp edge, said second projection comprising at least one of a point and a cutting edge.

10. The apparatus of claim 1, further comprising a hole disposed through said blade.

11. The apparatus of claim 1, wherein said handle comprises:
a central handle portion;
a butt portion engaged with said central handle portion; and
a bolt end in engagement with said butt portion.

12. The apparatus of claim 11, wherein said bolt end is adapted for hammering.

13. The apparatus of claim 11, wherein said central handle portion comprises a hollow interior.

14. The apparatus of claim 13, wherein said butt portion comprises a screwdriver handle.

15. The apparatus of claim 14, further comprising a screwdriver shaft operable with said screwdriver handle and is disposed within said hollow interior of said central handle portion when said butt portion is engaged with said central handle portion.

16. The apparatus of claim 15, further comprising at least one driver bit coupled to said screwdriver handle and disposed within said hollow interior of said central handle portion.

17. The apparatus of claim 16, wherein said at least one driver bit is removably operable with said screwdriver shaft.

18. The apparatus of claim 1, wherein said handle is arranged along a longitudinal axis.

19. The apparatus of claim 18, wherein said blade comprises a first edge, a second edge, and a third edge.

20. The apparatus of claim 19, wherein said first edge comprises a first concave well, said second edge comprises a second concave well, a third concave well, and a fourth concave well, and said third edge is generally perpendicular to said longitudinal axis.

21. The apparatus of claim 20, wherein at least two of said first concave well, said second concave well, said third concave well, and said fourth concave well define respective generally semi-circular wells.

22. The apparatus of claim 20, wherein at least two of said first concave well, said second concave well, said third concave well, and said fourth concave well define respective pluralities of strait sides comprising a semi-polygon well.

23. A tool system, comprising:
a tool handle;
a utility blade disposed on a first end of said tool handle; and
an extension pole for attachment to a second end of said tool handle opposite said first end.

24. The system of claim 23, further comprising a screwdriver having a screwdriver handle and a shaft coupled to a first end of said screwdriver handle, said screwdriver handle being engaged with said tool handle, and wherein said shaft is disposed at least partially within a hollow interior of said tool handle.

25. The system of claim 24, wherein said extension pole is engaged with a second end of said screwdriver handle.

26. A utility tool kit, comprising:
a tool apparatus, including:
a handle; and
a blade disposed on a first end of said handle;
a screwdriver for disposition on said handle; and
an elongated pole for disposition on said screwdriver.

27. The kit of claim 26, wherein said screwdriver comprises a butt end that is engageable with said handle while a screwdriver shaft coupled to said butt end is disposed within a hollow interior of said handle.

28. The kit of claim 26, wherein said screwdriver comprises a butt end that is engageable with an end bolt.

29. The kit as claimed in claim 28 wherein said elongated pole includes a first end for engagement with said butt end when said end bolt is removed from said butt end.

30. A painter's tool apparatus, comprising:
a handle;
a utility knife disposed on said handle; and
means for performing at least one painter's function disposed on said utility knife.

31. The apparatus as claimed in claim 30 further comprising a driving tool disposed on said handle.

32. The apparatus as claimed in claim 30 wherein said at least one painter's function includes cleaning a paint roller.

33. The apparatus as claimed in claim 32 wherein said at least one painter's function includes applying a putty.

34. The apparatus as claimed in claim 33 wherein said at least one painter's function includes scraping.

35. The apparatus as claimed in claim 34 wherein said at least one painter's function includes scraping caulk.

36. The apparatus as claimed in claim 35 wherein said at least one painter's function includes cutting.

37. The apparatus as claimed in claim 36 wherein said at least one painter's function includes driving a threaded fastener.

38. The apparatus as claimed in claim 37 wherein said at least one painter's function includes pulling nails.

39. The apparatus as claimed in claim 38 wherein said at least one painter's function includes can opening.

40. The apparatus as claimed in claim 30 wherein said handle includes a bolt end in engagement with said handle.

41. A tool comprising a handle and a multi-function blade connected to a first end of said handle, a second end of said handle including an engagement opening.

42. The tool as claimed in claim 41 wherein said multi-function blade comprises a first edge having a paint roller cleaning recess and a can opener portion, a second edge having a concave cutter, a first wrench, and a second wrench, a third edge disposed between said first edge and said second edge having a first protrusion contiguous with said concave cutter at least for scraping caulk and a second protrusion adjacent said paint roller cleaner recess.

43. The tool as claimed in claim 41 further comprising a through-hole for pulling nails disposed on said multi-function blade.

44. The tool as claimed in claim 41 further comprising a screwdriver for inserting into a hollow interior of said handle, said screwdriver having a screwdriver handle including an engagement portion for being in engagement with the opening of the handle.

45. The tool as claimed in claim 44 further comprising a bolt end having a shaft for engagement with an engagement opening disposed on said screwdriver handle.

46. The tool as claimed in claim 45 further comprising an elongated extension handle having a first end for being in engagement with said engagement opening on said screwdriver handle when said bolt end is removed from said engagement opening on said screwdriver handle.

47. A method for performing a painter's functions, comprising providing a tool having a handle with a multi-function blade having a first edge with a concave aperture, a second edge with a concave aperture and a hex profiled aperture, a third straight edge disposed between said first edge and said second edges and having a first protrusion adjacent said first edge and a second protrusion adjacent said second edge, and a through-hole disposed on said multi-function blade.

48. The method as claimed in claim 47 further comprising inserting a paint roller within said concave aperture on said first edge and running the paint roller along an edge of said concave aperture to clean the paint roller.

49. The method as claimed in claim 47 further comprising spreading a putty with said straight edge.

50. The method as claimed in claim 47 further comprising scraping a surface with said straight edge.

51. The method as claimed in claim 47 further comprising scraping caulk with said second protrusion.

52. The method as claimed in claim 47 further comprising removing a lid from a paint can with said first protrusion.

53. The method as claimed in claim 47 further comprising removing a nail with said through-hole.

54. A tool comprising:
a handle;
a utility blade operable with a first end of said handle;
a removable member adapted to engage said utility blade, said removable member comprising at least one of a point and a blade; and
a sleeve adapted to retain said removable member in engagement with said utility blade.
